(19) United States
(12) Patent Application Publication
(10) Pub. No.: US 2009/0040617 A1
(43) Pub. Date: Feb. 12, 2009

(54) WINDOW COVER FOR A DISPLAY DEVICE, METHOD OF MANUFACTURING THE SAME AND DISPLAY DEVICE HAVING THE WINDOW COVER

(75) Inventors: Hoi-Jin Kim, Diohainet City (KR); Chang-Woo Kang, Nam-gu (KR); Young Seo, Dalseo-gu (KR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Taeyang Electronics Co., Ltd.

(21) Appl. No.: 12/166,463

(22) Filed: Jul. 2, 2008

(30) Foreign Application Priority Data
Aug. 9, 2007 (KR) 10-2007-0080235

(51) Int. Cl. G02B 5/02; B05D 5/00; B32B 33/00

(52) U.S. Cl. 359/599; 427/164; 428/203

(57) ABSTRACT

A window cover for a display device includes a base plate, a printed layer, a specular layer and a light-providing sheet. The base plate has a first face and a second face opposite to the first face. The printed layer is arranged on the first face of the base plate. Further, the printed layer has a printed pattern formed. The specular layer is arranged on the printed layer to reflect a light incident to the specular layer. The light-providing sheet is placed on the second face of the base plate to provide the light to the printed layer. The display device may have improved appearance design.

### PRIORITY STATEMENT

This application claims priority under 35 USC § 119 to Korean Patent Application No. 2007-80235 filed on Aug. 9, 2007 in the Korean Intellectual Property Office (KIPO), the contents of which are herein incorporated by reference in their entirety.

### BACKGROUND OF THE INVENTION

1. Field of the Invention

Example embodiments of the present invention relate to a window cover for a display device, a method of manufacturing the same and a display device having the window cover. More particularly, example embodiments of the present invention relate to a window cover for a portable display device such as a cellular phone, a method of manufacturing the window cover and a display device having the window cover.

2. Description of the Related Art

A display device such as a cellular phone may generally include a window cover installed at a front surface of the display device. The window cover may define an appearance of the display device. Thus, a user may recognize a design of the display device in which the window cover is employed through the window cover.

A conventional window cover may be manufactured by an insert injection molding process, an inmold injection molding process, etc. However, when a design of the conventional window cover is determined, the design may not be provided with any changes. Additionally, the user may be tired of the design. Furthermore, the design may be diversified in accordance with requirements of the user. Therefore, designs of a window cover with which various changes are provided may be required from the user.

### SUMMARY OF THE INVENTION

Example embodiments of the present invention provide a window cover for a display device that is capable of improving an appearance design of the display device.

Example embodiments of the present invention provide a method of manufacturing a window cover for a display device that is capable of improving an appearance design of the display device.

Example embodiments of the present invention also provide a display device having a window cover improving an appearance design of the display device.

A window cover for a display device in accordance with one aspect of the present invention includes a base plate, a printed layer, a specular layer and a light-providing sheet. The base plate has a first face and a second face opposite to the first face. The printed layer is arranged on the first face of the base plate. Additionally, the printed layer has a printed pattern formed. The specular layer is arranged on the printed layer to reflect a light incident to the specular layer. The light-providing sheet is placed on the second face of the base plate to provide the light to the printed layer.

In example embodiments, the window cover may include a high molecular film on the specular layer, and a hard coating layer on the high molecular film to protect the high molecular film. The window cover may further include a primer layer interposed between the high molecular film and the hard coating layer to attach the hard coating layer to the high molecular film. Furthermore, the window cover may include a first binder layer interposed between the base plate and the printed layer to attach the printed layer to the base plate, and a second binder layer interposed between the base plate and the light-providing sheet to attach the light-providing sheet to the base plate.

In example embodiments, the printed layer may include a first sub-printed layer having a first printed pattern on the first face of the base plate, and a second sub-printed layer having a second printed pattern on the first sub-printed layer.

In example embodiments, the window cover may further include a light source arranged at a side of the light-providing sheet to provide the light to the light-providing sheet. The light-providing sheet may have a light incident face, a light exiting face and a confronting face. The light emitted from the light source may be irradiated to the light incident face. The light incident to the light incident face may exit through the light exiting face. The confronting face may confront the light exiting face. The confronting face has a recess formed at a surface portion of the confronting face, and a light-scattering pattern defined by the recess to scatter the incident light toward the light exiting face. The recess may have an annular shape. The light-scattering pattern may be positioned at a central portion of the annular recess to be surrounded by the annular recess.

In a method of manufacturing a window cover for a display device in accordance with another aspect of the present invention, a specular layer for reflecting a light incident to the specular layer is formed on a high molecular film. A printed layer having a printed pattern is formed on the specular layer. A light-providing sheet for providing the light to the printed layer is prepared. The high molecular film having the specular layer and the printed layer is attached to a base plate having a first face and a second face opposite to the first face. Here, the printed layer confronts the first face of the base plate. The light-providing sheet is then attached to the second face of the base plate.

In example embodiments, the high molecular film may have a first face and a second face opposite to the first face. The specular layer may be formed on the second face of the high molecular film. The method may further include attaching a hard coating layer for protecting the high molecular film to the first face of the high molecular film before forming the specular layer.

In example embodiments, the hard coating layer may be attached to the high molecular film using a primer layer. Further, the high molecular film having the specular layer and the printed layer may be attached to the first face of the base plate by a hot-melt printing process. The light-providing sheet may be attached to the second face of the base plate by a hot-melt printing process.

In example embodiments, attaching the high molecular film having the specular layer and the printed layer to the first face of the base plate and attaching the light-providing sheet to the second face of the base plate may be performed simultaneously with each other. Attaching the high molecular film having the specular layer and the printed layer to the first face of the base plate and attaching the light-providing sheet to the second face of the base plate may include arranging the light-providing sheet on an upper mold, arranging the high molecular film having the specular layer and the printed layer on a lower mold, and injecting an injection resin to the upper mold and the lower mold at an injection temperature to form the base plate to which the high molecular film having the specular layer and the printed layer and the light-providing sheet are attached.

In example embodiments, the printed pattern may be formed on the printed layer by a screen printing process or a halftone dot printing process. Further, forming the printed layer may include forming a first sub-printed layer having a first printed pattern on the specular layer, and forming a second sub-printed layer having a second printed pattern on the first sub-printed layer.

In example embodiments, the light-providing sheet may be prepared using a stamper mold that includes a transcription pattern having a concave portion formed at a surface portion of the transcription pattern, and a convex portion protruded from a bottom face of the concave portion.

A display device in accordance with still another aspect of the present invention includes a light source unit, a display panel and a window cover. The light source unit emits a light. The display panel is positioned over the light source unit to display an image using the light. The window cover is arranged over the display panel to cover the display panel. The window cover includes a base plate having a first face and a second face opposite to the first face, a printed layer arranged on the first face of the base plate, the printed layer having a printed pattern, a specular layer arranged on the printed layer to reflect a light incident to the specular layer, and a light-providing sheet arranged on the second face of the base plate to provide the light toward the printed layer.

According to example embodiments of the present invention, the printed patterns of the window cover may be selectively displayed by selectively providing the light from the light-providing sheet so that the display device may have improved appearance design. Additionally, the window cover may be provided with the printed layer having the printed pattern and the specular layer adjacent to the printed layer. Thus, characters, figures, symbols, etc., on the printed patterns of the window cover may be selectively displayed by selectively providing the light from the light-providing sheet so that the display device may have improved appearance design. Furthermore, the above-mentioned patterns may not be displayed when the display device is not used. The above-mentioned patterns may be selectively displayed when the light is provided to the light-providing sheet.

### BRIEF DESCRIPTION OF THE DRAWINGS

The above and other features and advantages of the invention will become readily apparent by reference to the following detailed description when considered in conjunction with the accompanying drawings wherein:

FIG. 1 is a plan view illustrating a window cover for a display device in accordance with example embodiments of the present invention;

FIG. 2 is a cross-sectional view taken along a line I-I′ in FIG. 1:

FIG. 3 is a perspective view illustrating a light-providing sheet of the window cover for the display device in FIG. 1;

FIG. 4 is a cross-sectional view illustrating a window cover for a display device in accordance with example embodiments of the present invention;

FIG. 5 is a flow chart illustrating a method of manufacturing the window cover in FIG. 4;

FIGS. 6 to 11 are cross-sectional views illustrating the method in FIG. 5;

FIG. 12 is a cross-sectional view illustrating a window cover for a display device in accordance with example embodiments of the present invention; and

FIG. 13 is a cross-sectional view illustrating a display device in accordance with example embodiments of the present invention.

### DESCRIPTION OF THE EMBODIMENTS

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” may encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

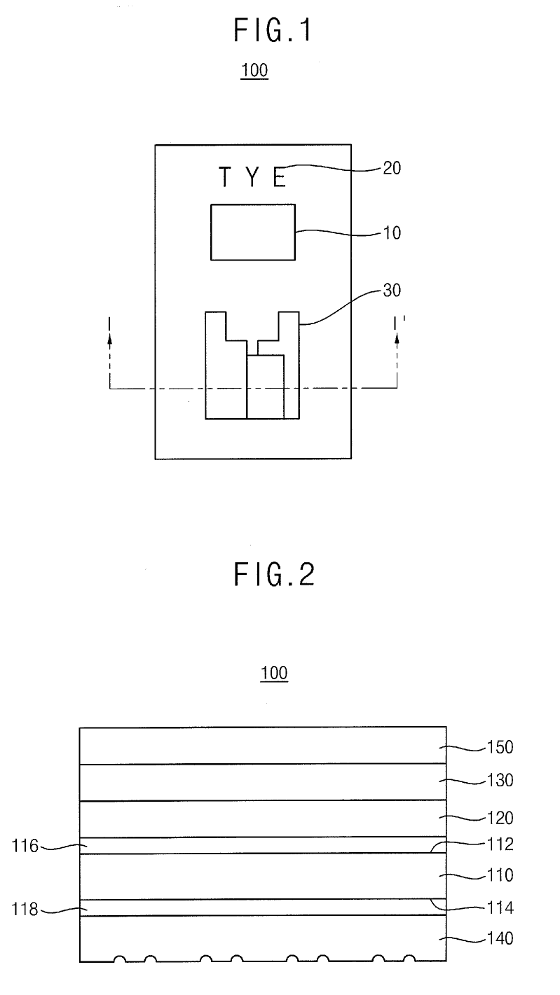

FIG. 1 is a plan view illustrating a window cover for a display device in accordance with example embodiments of the present invention, and FIG. 2 is a cross-sectional view taken along a line I-I′ in FIG. 1.

Referring to FIGS. 1 and 2, a window cover 100 for a display device of this example embodiment includes a base plate 110, a printed layer 120, a specular layer 130 and a light-providing sheet 140.

The base plate 110 may include a plate shape having a predetermined thickness. The base plate 110 has a first face 112 corresponding to an upper face of the base plate 110, and a second face 114, which corresponds to a lower face of the base plate 110, opposite to the first face 112. In example embodiments, the base plate 110 may include polymethyl methacrylate (PMMA), poly carbonate (PC), etc.

The printed layer 120 is positioned on the first face 112 of the base plate 110. A printed pattern (not illustrated) is formed on the printed layer 120. For example, the printed pattern may be formed by a screen printing process. Alternatively, the printed pattern may be a halftone dot printing process for effectively displaying diffusion effects. For example, the printed layer may include a desired pattern such as a character, a figure, a symbol, etc.

The specular layer 130 is arranged on the printed layer 120 to reflect a light incident to the specular layer 130 from the outside. The specular layer 130 may include a metal for providing the specular layer 130 with effective reflection functions. Further, the specular layer 130 may be formed simultaneously with formation of a high molecular film 150 illustrated later by a multi-deposition process.

The light-providing sheet 140 is arranged on the second face 114 of the base plate 110 to provide the light toward the printed layer 120. The light-providing sheet 140 may have a structure for allowing the light to uniformly distribute toward the printed layer 120. Here, the light-provide sheet 140 may function as a wave guide sheet.

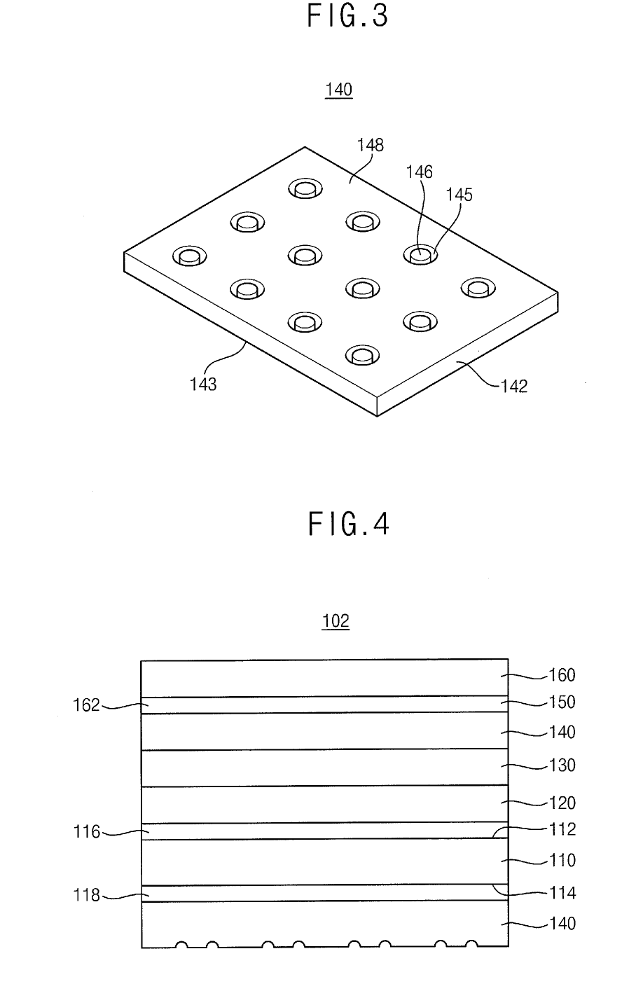

Hereinafter, the light-providing sheet 140 will be described in detail with reference to FIG. 3.

FIG. 3 is a perspective view illustrating a light-providing sheet of the window cover for the display device in FIG. 1.

Referring to FIG. 3, the light-providing sheet 140 has a light incident face 142, a light exiting face 143 and a confronting face 148. The light emitted from a light source (not illustrated) is irradiated into the light incident face 142. The light incident to the light incident face 142 exits through an entire face of the light exiting face 143. The confronting face 148 confronts the light exiting face 143. Further, the confronting face 148 includes a recess 145 formed at a surface portion of the confronting face 148, and a light-scattering pattern 146 positioned in the recess 145 to scatter the incident light toward the light exiting face 143.

In example embodiments, the light-providing sheet 140 may have a film shape having a uniform thickness. The light incident face 142 corresponds to a side face of the light-providing sheet 140. Further, the light exiting face 143 corresponds to a lower face of the light-providing sheet 140 substantially perpendicular to the light incident face 142. Thus, the confronting face 148 corresponds to an upper face of the light-providing sheet 140.

A luminance-controlling member (not illustrated) for controlling luminance of the light exiting through the light exiting face 143 such as a film, a prism sheet, etc., may be arranged on the light exiting face 143. A keypad (not illustrated) may be placed over the luminance-controlling member. Characters and numbers on the keypad may be discriminated by the light exiting through the light exiting face 143.

The light-scattering pattern 146 is surrounded by the recess 145 formed from the surface of the confronting face 148. In this example embodiment, the recess 145 may have an annular shape. Further, the light-scattering pattern 146 may be positioned at a central portion of the annular recess 145 to be surrounded by the annular recess 145.

The light may be selectively irradiated to the light-providing sheet 140 from the outside in accordance with a predetermined condition. For example, in a display device (not illustrated) employing the window cover 100, when the window cover 100 rotatably connected to a body of the display device using a hinge is opened, the light may be provided to the keypad through the light-providing sheet 140 so as to discriminate the keypad under dark illumination. In this case, the opening of the window cover 100 may correspond to the condition that the light is provided to the light-providing sheet 140. However, the above-mentioned condition of the light provision may be exemplarily described. Alternatively, the light may be selectively provided to the light-providing sheet 140 in accordance with various other conditions.

When the light is not provided to the light-providing sheet 140, i.e., the window cover 100 of the display device is not opened, the light may not be transmitted from the light-providing sheet 140 to the printed layer 120. Thus, the incident light from the outside is reflected from the specular layer 130 so that the printed pattern on the printed layer 120 may be invisible when a user looks at the display device.

When the light is provided to the light-providing sheet 140, i.e., the window cover 100 of the display device is opened, the light may be transmitted to the light-providing sheet 140. The light in the light-providing sheet 140 may then uniformly diffuse. The diffusing light may exit through the light-providing sheet 140. The light may then be transmitted to the printed layer 120 so that the printed pattern on the printed layer 120 may be visible.

A light source (not illustrated) for emitting the light, which is provided to the light-providing sheet 140, may include a light emitting diode (LED) for emitting the light so as to discriminate the keypad of the display device employing the window cover 100 under the dark illumination. Additionally, the light source may be arranged at a side of the light-providing sheet 140.

By the above-mentioned constitution, the window cover 100 for the display device may selectively display the various patterns such as the characters, the figures, the symbols, etc., so that the user may feel aesthetic in accordance with changes of various designs.

Referring again to FIG. 2, the window cover 100 may further include the high molecular film 150. The high molecular film 150 is placed on the specular layer 130. In example embodiments, the high molecular film 150 may include PC, polyester (PET), etc. The window cover 100 may additionally include a first binder layer 116 interposed between the base plate 110 and the printed layer 120 to attach the printed layer 120 to the base plate 110. Furthermore, the window cover 100 may include a second binder layer 118 interposed between the base plate 110 and the light-providing sheet 140 to attach the light-providing sheet 140 to the base plate 110.

Referring again to FIG. 1, the window cover 100 may have a window 10 for allowing the user to see a display panel (not illustrated) of the display device having the window cover 100. Further, a first pattern 20 on the window cover 100 may be formed by an inmold injection molding process. The first pattern 20 may correspond to a constantly displayed pattern. In contrast, a second pattern 30 on the window cover 100 may be formed on the printed layer 120. The second pattern 30 may correspond to a selectively displayed pattern dependent upon the light provision of the light-providing sheet 140.

FIG. 4 is a cross-sectional view illustrating a window cover for a display device in accordance with example embodiments of the present invention.

In FIG. 4, the window cover 102 for the display device includes elements substantially the same as those of the window cover 100 in FIGS. 1 and 2 except for a hard coating layer 160 and a primer layer 162 on the high molecular film 150. Thus, the same reference numerals refer to the same elements and any further illustrations with respect to the same elements are omitted herein for brevity.

Referring to FIG. 4, the window cover 102 of this example embodiment includes the base plate 110, the printed layer 120, the specular layer 130, the light-providing sheet 140, the high molecular film 150 and the hard coating layer 160.

The hard coating layer 160 is placed on the high molecular film 150 to protect the high molecular film 150.

The primer layer 162 may be interposed between the high molecular film 150 and the hard coating layer 160. The primer layer 162 may function as to attach the hard coating layer 160 to the high molecular film 150.

By the above-mentioned constitution, the window cover 102 for the display device may selectively display the various patterns such as the characters, the figures, the symbols, etc., so that the user may feel aesthetic in accordance with changes of various designs. Further, the hard coating layer may protect the display device having the window cover 102 from external impacts so that the display device may have reinforced durability and long life span. As a result, the display device may have improved reliability with respect to the user.

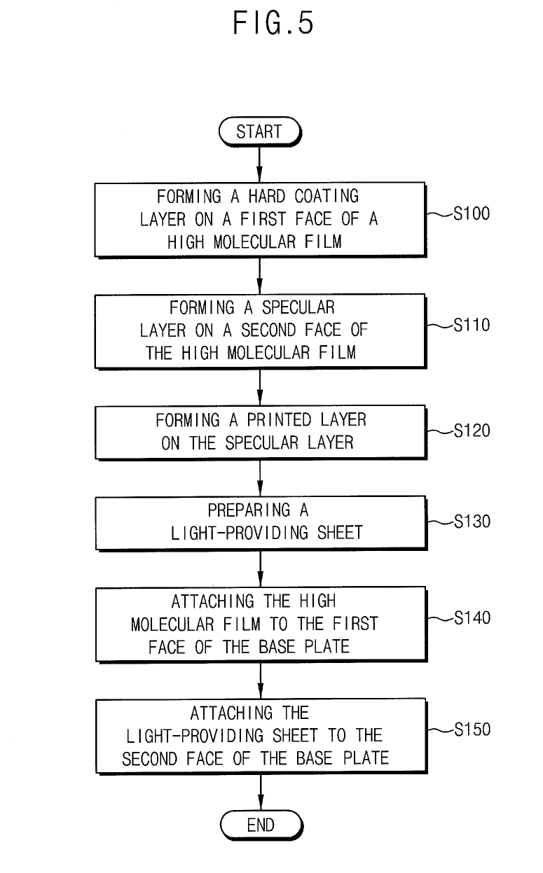

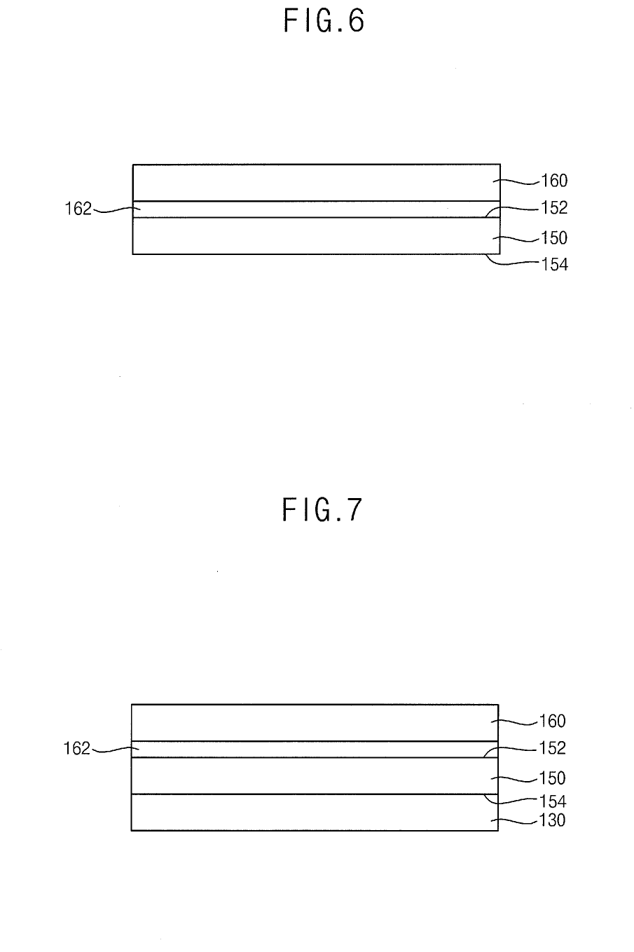

FIG. 5 is a flow chart illustrating a method of manufacturing the window cover in FIG. 4, and FIGS. 6 to 11 are cross-sectional views illustrating the method described in FIG. 5.

The method of manufacturing the window cover 102 in FIG. 4 is performed as follows.

Referring to FIGS. 5 and 6, in step S100, the hard coating layer 160 for protecting the high molecular film 150 is attached to a first face 152 of the high molecular film 150. The hard coating layer 160 may be attached to the high molecular film 150 using the primer layer 162.

Referring to FIGS. 5 and 7, in step S110, the specular layer 130 for reflecting the incident light is formed on a second face of the high molecular film 150 opposite to the first face.

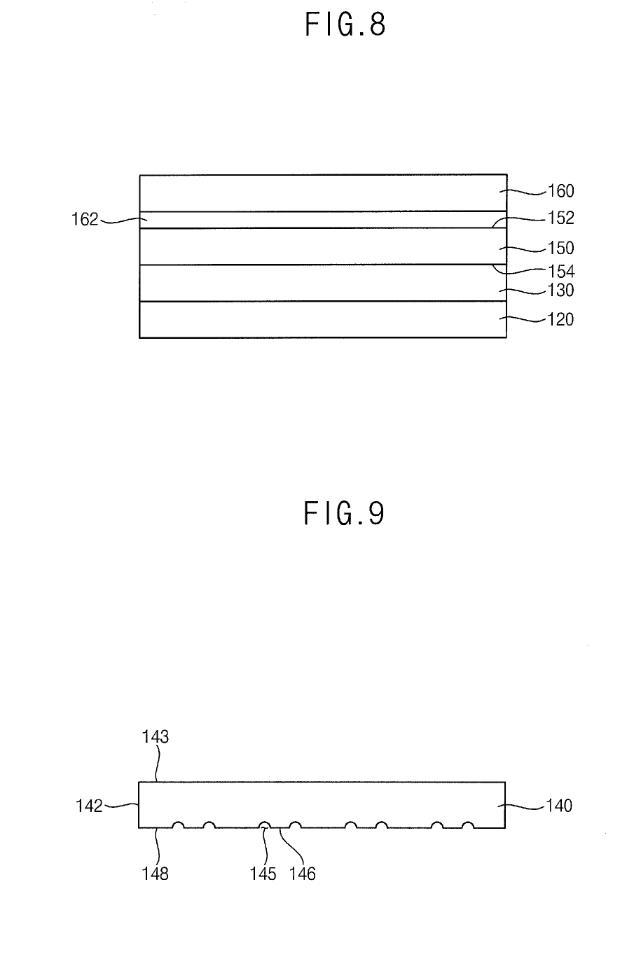

Referring to FIGS. 5 and 8, in step S120, the printed layer 120 having the printed pattern is formed on the specular layer 130. The printed pattern on the printed layer 120 may be formed by a screen printing process, a halftone dot printing process, etc. The halftone dot printing process may use four-colored plates of cyan (C), magenta (M), yellow (Y) and black (K). Further, the high molecular film 150 having the printed layer 120 may be stamped to have a desired shape.

Referring to FIGS. 5 and 9, in step S130, the light-providing sheet 140 for providing the light to the printed layer 120 is prepared.

In example embodiments, the light-providing sheet 140 has the light incident face 142, the light exiting face 143 and the confronting face 148. The light emitted from the light source is irradiated into the light incident face 142. The light incident to the light incident face 142 exits through an entire face of the light exiting face 143. The confronting face 148 confronts the light exiting face 143.

In a process for manufacturing the light-providing sheet 140, a stainless steel (SUS) plate may be engraved using an ND-YAG laser. The engraved plate may then be heated to a temperature of about 120° C. to about 180° C. A pattern may be formed at a surface portion of a PC film using the engraved plate.

For example, the light-providing sheet 140 may be prepared using a stamper mold. The stamper mold may include a transcription pattern that has a concave portion formed at a surface portion of the transcription pattern, and a convex portion protruded from a bottom face of the concave portion. Thus, the confronting face 148 of the light-providing sheet 140 may include a recess 145 formed at a surface portion of the confronting face 148, and a light-scattering pattern 146 positioned in the recess 145 to scatter the incident light toward the light exiting face 143.

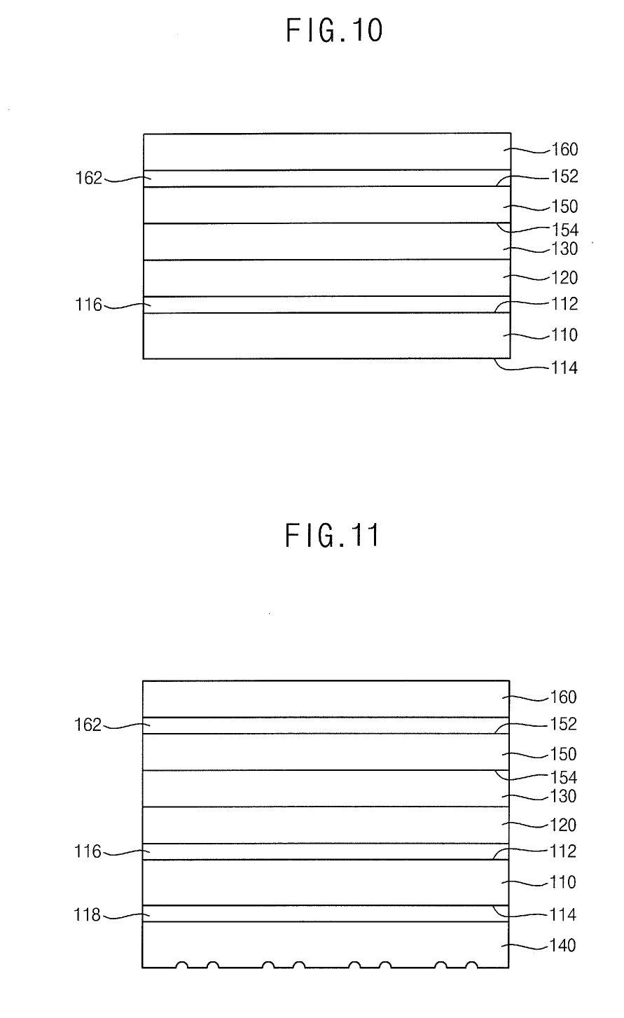

Referring to FIGS. 5 and 10, in step S140, the high molecular film 150 having the specular layer 130 and the printed layer 120 is attached to the base plate 110 having the first face 112 and the second face 114 opposite to the first face 112. Here, the printed layer 120 confronts the first face 112 of the base plate 110.

In example embodiments, the high molecular film 150 having the specular layer 130 and the printed layer 120 may be attached to the first face 112 of the base plate 110 by a hot-melt printing process. Thus, the first binder layer 116 may be formed between the base plate 110 and the printed layer 120.

Referring to FIGS. 5 and 11, the light-providing sheet 140 is then attached to the second face 114 of the base plate 110.

In example embodiments, the light-providing sheet 140 may be attached to the second face 114 of the base plate 110 by a hot-melt printing process. Thus, the second binder layer 118 may be formed between the base plate 110 and the light-providing sheet 140. The process for attaching the high molecular film 150 having the specular layer 130 and the printed layer 120 to the first face 112 of the base plate 110 and the process for attaching the light-providing sheet 140 to the second face 114 of the base plate 110 may be performed simultaneously with each other by an insert injection molding process, an inmold injection molding process, etc.

In example embodiments, the process for attaching the high molecular film 150 having the specular layer 130 and the printed layer 120 to the first face 112 of the base plate 110 and the process for attaching the light-providing sheet 140 to the second face 114 of the base plate 110 may include arranging the light-providing sheet 140 on an upper mold, arranging the high molecular film 150 having the specular layer 130 and the printed layer 120 on a lower mold, and injecting an injection resin at an injection temperature to the upper mold and the lower mold to form the base plate 110 to which the light-providing sheet 140 and the high molecular film 150 having the specular layer 130 and the printed layer 120 are attached. For example, the injection temperature may be about 240° C. to about 280° C.

By the above-mentioned processes, the window cover 102 for the display device is manufactured.

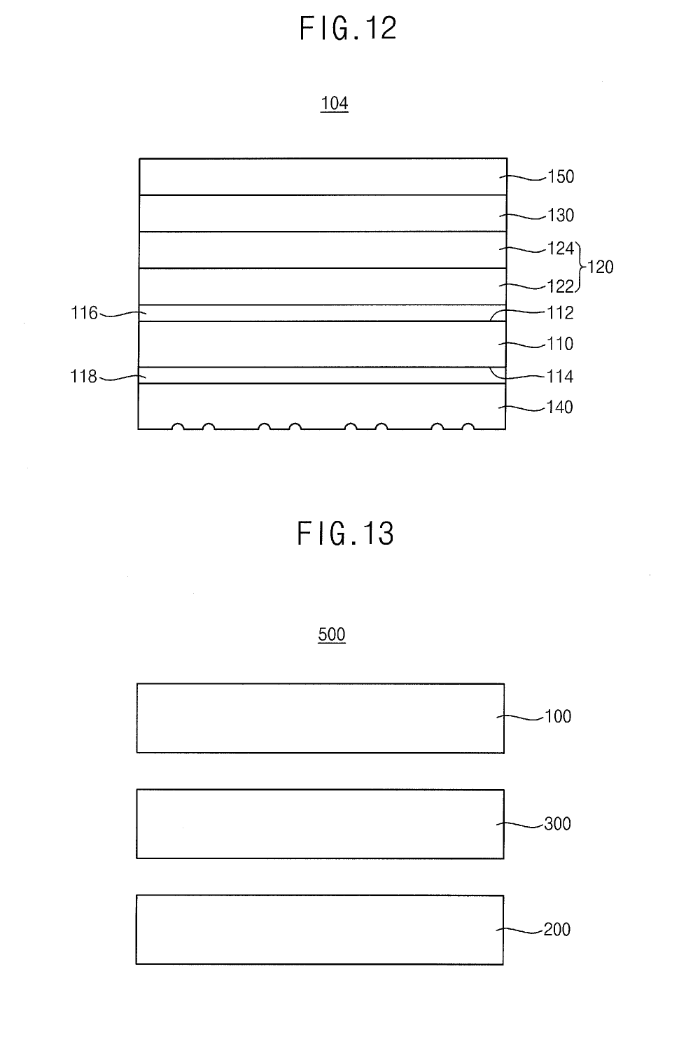

FIG. 12 is a cross-sectional view illustrating a window cover for a display device in accordance with example embodiments of the present invention.

In FIG. 12, the window cover 104 includes elements substantially the same as those of the window cover 100 in FIG. 2 except that the printed layer includes a first sub-printed layer 122 and a second sub-printed layer 124. Thus, the same reference numerals refer to the same elements and any further illustrations with respect to the same elements are omitted herein for brevity.

Referring to FIG. 12, the printed layer 120 includes the first sub-printed layer 122 and the second sub-printed layer 124. The first sub-printed layer 122 is arranged on the first face 112 of the base plate 110. A first printed pattern (not illustrated) is formed on the first sub-printed layer 122.

The second sub-printed layer 124 is arranged on the first sub-printed layer 122. A second printed pattern (not illustrated) is formed on the second sub-printed layer 124.

In example embodiments, since the printed layer 120 includes the first sub-printed layer 122 and the second sub-printed layer 124, different two patterns having a three-dimensional effect may be displayed. Further, the first sub-printed layer 122 and the second sub-printed layer 124 may be formed by different printing processes so that the printed patterns having different display effects may be accomplished.

Meanwhile, a method of manufacturing the window cover 104 in FIG. 12 is substantially the same as the method of manufacturing the window cover 102 in FIG. 5 except that forming the printed layer 120 includes forming the first sub-printed layer 122 and the second sub-printed layer 124. Thus, any further illustrations with respect to the method of manufacturing the window cover 104 are omitted herein for brevity.

FIG. 13 is a cross-sectional view illustrating a display device in accordance with example embodiments of the present invention.

Referring to FIG. 13, a display device 500 of this example embodiment includes the window cover 100, a light source unit 200 and a display panel 300. The light source unit 200 emits a light. The display panel 300 is arranged over the light source unit 200 to display an image using the light. The window cover 100 is placed over the display panel 300 to cover the display panel 300. The window cover 100 may have a construction substantially the same as that of the window cover described with reference to FIG. 2. Thus, any further illustrations with respect to the window cover 100 are omitted herein for brevity.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A window cover for a display device, comprising:
a base plate having a first face and a second face opposed to the first face;
a printed layer arranged on the first face of the base plate, the printed layer having a printed pattern;
a specular layer arranged on the printed layer to reflect a light incident to the specular layer; and
a light-providing sheet arranged on the second face of the base plate to provide the light toward the printed layer.

2. The window cover for the display panel of claim 1, further comprising a high molecular film arranged on the specular layer.

3. The window cover for the display panel of claim 2, further comprising a hard coating layer arranged on the high molecular film to protect the high molecular film.

4. The window cover for the display panel of claim 3, further comprising a primer layer disposed between the high molecular film and the hard coating layer to attach the hard coating layer to the high molecular film.

5. The window cover for the display panel of claim 1, further comprising a first binder layer disposed between the base plate and the printed layer to attach the printed layer to the base plate.

6. The window cover for the display panel of claim 1, further comprising a second binder layer disposed between the base plate and the light-providing sheet to attach the light-providing sheet to the base plate.

7. The window cover for the display panel of claim 1, wherein the printed layer comprises:
a first sub-printed layer arranged on the first face of the base plate, the first sub-printed layer having a first printed pattern; and
a second sub-printed layer arranged on the first sub-printed layer, the second sub-printed layer having a second printed pattern.

8. The window cover for the display panel of claim 1, further comprising a light source arranged at a side of the light-providing sheet to emit the light toward the light-providing sheet.

9. The window cover for the display panel of claim 1, wherein the light-providing sheet comprises:
a light incident face to which the light is irradiated;
a light exiting face through which the light incident to the light incident face exits; and
a confronting face opposed to the light exiting face, the confronting face having a recess formed at a confronting face and a light-scattering pattern formed in the recess to scatter the incident light toward the light exiting face.

10. The window cover for the display panel of claim 9, wherein the recess has an annular shape, and the light-scattering pattern locates at a central portion of the annular recess to be surrounded by the annular recess.

11. A method of manufacturing a window cover for a display device, comprising:
forming a specular layer for reflecting a light on a high molecular film;
forming a printed layer having a printed pattern on the specular layer;
preparing a light-providing sheet for providing the light toward the printed layer;
attaching the high molecular film having the specular layer and the printed layer to a base plate having a first face and a second face opposite to the first face, the printed layer confronting the first face of the base plate; and
attaching the light-providing sheet to the second face of the base plate.

12. The method of claim 11, wherein the high molecular film has a first face and a second face opposite to the first face, the specular layer is formed on the second face of the high molecular film, and the method further comprises attaching a hard coating layer for protecting the high molecular film to the first face of the high molecular film before forming the specular layer.

13. The method of claim 12, wherein the hard coating layer is attached to the high molecular film using a primer layer.

14. The method of claim 11, wherein the high molecular film having the specular layer and the printed layer is attached to the first face of the base plate by a hot-melt printing process, and the light-providing sheet is attached to the second face of the base plate by a hot-melt printing process.

15. The method of claim 11, wherein attaching the high molecular film having the specular layer and the printed layer to the first face of the base plate and attaching the light-providing sheet to the second face of the base plate are performed simultaneously with each other.

16. The method of claim 15, wherein attaching the high molecular film having the specular layer and the printed layer to the first face of the base plate and attaching the light-providing sheet to the second face of the base plate comprise:
arranging the light-providing sheet on an upper mold;
arranging the high molecular film having the specular layer and the printed layer on a lower mold; and
injecting an injection resin to the upper mold and the lower mold at an injection temperature to form the base plate to which the high molecular film having the specular layer and the printed layer and the light-providing sheet are attached.

17. The method of claim 11, wherein the printed pattern is formed on the printed layer by a screen printing process or a halftone dot printing process.

18. The method of claim 11, wherein forming the printed layer comprises:
forming a first sub-printed layer having a first printed pattern on the specular layer; and
forming a second sub-printed layer having a second printed pattern on the first sub-printed layer.

19. The method of claim 11, wherein the light-providing sheet is prepared using a stamper mold that includes a transcription pattern having a concave portion formed at a surface portion of the transcription pattern, and a convex portion protruded from a bottom face of the concave portion.

20. A display device comprising:
a light source unit for emitting a light;
a display panel positioned over the light source unit to display an image using the first light; and
a window cover arranged over the display panel to cover the display panel,
wherein the window cover includes:
a base plate having a first face and a second face opposite to the first face;
a printed layer arranged on the first face of the base plate, the printed layer having a printed pattern;
a specular layer arranged on the printed layer to reflect the light incident to the specular layer; and
a light-providing sheet arranged on the second face of the base plate to provide the light toward the printed layer.
